(19) United States
(12) Patent Application Publication
(10) Pub. No.: US 2025/0294088 A1
(43) Pub. Date: Sep. 18, 2025

(54) DISPLAY DEVICE AND ELECTRONIC DEVICE

(71) Applicant: Samsung Display Co., LTD., Yongin-si (KR)

(72) Inventors: Tae Chang KIM, Yongin-si (KR); Ji Heon LEE, Yongin-si (KR)

(21) Appl. No.: 19/056,122

(22) Filed: Feb. 18, 2025

(30) Foreign Application Priority Data
Mar. 14, 2024 (KR) 10-2024-0035738

(51) Int. Cl. H04M 1/02

(52) U.S. Cl. CPC H04M 1/0218; H04M 1/0268

(57) ABSTRACT

A display device includes: a display panel including a first area, a folding area, and a second area, which are arranged along a first direction, wherein the folding area is folded with respect to a folding axis extending along a second direction intersecting the first direction; and a support plate on a rear surface of the display panel, the support plate including a pattern portion overlapping with the folding area, wherein the pattern portion includes a first recess portion, a second recess portion, and an opening portion between the first recess portion and the second recess portion, and wherein, a radius of curvature of the folding area is r in a state in which the display panel is folded, and in the state in which the display panel is folded, a width of the pattern portion in the first direction is (πr+2)/2 or more and πr+2 or less.

### CROSS-REFERENCE TO RELATED APPLICATION

The present application claims priority to and the benefit of Korean patent application No. 10-2024-0035738 filed on Mar. 14, 2024, in the Korean Intellectual Property Office, the entire disclosure of which is incorporated herein by reference.

### BACKGROUND

### 1. Field

Aspects of some embodiments of the present disclosure generally relate to a display device and an electronic device including the same.

### 2. Description of the Related Art

Recently, as interest in information displays has increased, research and development of display devices has been continuously conducted.

The above information disclosed in this Background section is only for enhancement of understanding of the background and therefore the information discussed in this Background section does not necessarily constitute prior art.

### SUMMARY

Aspects of some embodiments include a display device having relatively improved visibility.

According to some embodiments of the present disclosure, a display device includes: a display panel including a first area, a folding area, and a second area, which are arranged along a first direction, wherein the folding area is folded with respect to a folding axis defined along a second direction intersecting the first direction; and a support plate on a rear surface of the display panel, the support plate including a pattern portion overlapping with the folding area, wherein the pattern portion includes a first recess portion, a second recess portion, and an opening portion between the first recess portion and the second recess portion, and wherein, when a radius of curvature of the folding area is r in a state in which the display panel is folded, a width of the pattern portion in the first direction is (πr+2)/2 or more and πr+2 or less.

According to some embodiments, a width of the opening portion in the first direction may be (πr+2)/2, and a width of the first recess portion in the first direction may be (πr+2)/4.

According to some embodiments, a width of the first recessed portion in the first direction may be equal to a width of the second recess portion in the first direction.

According to some embodiments, the display device may further include a hinge plate on a rear surface of the support plate.

According to some embodiments, the hinge plate may include a first hinge plate and a second hinge plate, which are spaced apart from each other.

According to some embodiments, the first hinge plate may overlap with the first recess portion, and the second hinge plate may overlap with the second recess portion.

According to some embodiments, the display device may further include: a first digitizer between the support plate and the first hinge plate; and a second digitizer between the support plate and the second hinge plate.

According to some embodiments, the first digitizer and the second digitizer may be spaced apart from each other.

According to some embodiments, the display device may further include: a first spacer between the first digitizer and the first hinge plate; and a second spacer between the second digitizer and the second hinge plate.

According to some embodiments, the first spacer and the second spacer may be spaced apart from each other.

According to some embodiments of the present disclosure, a display device includes: a support plate including a first support portion, a pattern portion, and a second support portion, which are arranged along a first direction; and a display panel on a top surface of the support plate, the display panel being folded with respect to a folding axis defined along a second direction intersecting the first direction in a folding area overlapping with the pattern portion, wherein the pattern portion includes a first recess portion, a second recess portion, and an opening portion between the first recess portion and the second recess portion, wherein, when a radius of curvature of the folding area is r in a state in which the display panel is folded, a width of the pattern portion in the first direction is (πr+2)/2 or more and πr+2 or less.

According to some embodiments, a width of the opening portion in the first direction may be (πr+2)/2, and a width of the first recess portion in the first direction may be (πr+2)/4.

According to some embodiments, a width of the first recessed portion in the first direction may be equal to a width of the second recess portion in the first direction.

According to some embodiments, the display device may further include a hinge plate on a rear surface of the support plate.

According to some embodiments, the hinge plate may include a first hinge plate and a second hinge plate, which are spaced apart from each other.

According to some embodiments, the first hinge plate may overlap with the first recess portion, and the second hinge plate may overlap with the second recess portion.

According to some embodiments, the display device may further include a digitizer on a rear surface of the support plate.

According to some embodiments, the digitizer may include a first digitizer and a second digitizer, which are spaced apart from each other.

According to some embodiments, the first digitizer may overlap with the first support portion, and the second digitizer may overlap with the second support portion.

According to some embodiments, the display device may further include: a first hinge plate on a rear surface of the first digitizer; and a second hinge plate on a rear surface of the second digitizer.

According to some embodiments of the present disclosure, an electronic device includes: a processor to provide input image data, and a display device to display an image based on the input image data, the display device including sub-pixel areas, wherein the display device comprises a display panel including a first area, a folding area, and a second area, which are arranged along a first direction, wherein the folding area is folded with respect to a folding axis defined along a second direction intersecting the first direction; and a support plate on a rear surface of the display panel, the support plate including a pattern portion overlapping with the folding area, wherein the pattern portion includes a first recess portion, a second recess portion, and an opening portion between the first recess portion and the second recess portion, and wherein, when a radius of curvature of the folding area is r in a state in which the display panel is folded, a width of the pattern portion in the first direction is (πr+2)/2 or more and πr+2 or less.

### BRIEF DESCRIPTION OF THE DRAWINGS

Aspects of some embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a plan view illustrating an example of an unfolded state of a display device according to some embodiments of the present disclosure.

FIG. 2 is a side view illustrating an example of a folded state of the display device according to some embodiments of the present disclosure.

FIGS. 3 and 4 are sectional views illustrating a display device according to some embodiments of the present disclosure.

FIG. 5 is a sectional view illustrating an example of an unfolded state of a folding area according to some embodiments of the present disclosure.

FIG. 6 is a sectional view illustrating an example of a folded state of the folding area according to some embodiments of the present disclosure.

FIGS. 7 to 10 are plan views illustrating pattern portions of a support plate according to some embodiments of the present disclosure.

FIGS. 11 and 12 are sectional views illustrating pattern portions of the support plate according to some embodiments of the present disclosure.

FIG. 13 is a schematic block diagram illustrating an electronic device including a display device in accordance with an embodiment.

FIG. 14 is a schematic diagram illustrating an example where the electronic device of FIG. 13 is a smartphone.

FIG. 15 is a schematic diagram illustrating an example where the electronic device of FIG. 13 is a tablet computer.

### DETAILED DESCRIPTION

The effects and characteristics of some embodiments of the present disclosure and a method of achieving the effects and characteristics will be clear by referring to the embodiments described below in detail together with the accompanying drawings. However, embodiments according to the present disclosure are not limited to the embodiments disclosed herein but may be implemented in various forms. The embodiments are provided by way of example only so that a person of ordinary skilled in the art can fully understand the features in the present disclosure and the scope thereof. Therefore, the present disclosure can be defined by the scope of the appended claims.

The terminology used herein is for the purpose of describing particular embodiments only and is not construed as limiting the inventive concept. As used herein, the singular forms are intended to include the plural forms as well, unless the context clearly indicates otherwise. The terms “comprises/includes” and/or “comprising/including,” when used in this specification, specify the presence of mentioned component, step, operation and/or element, but do not exclude the presence or addition of one or more other components, steps, operations and/or elements.

When described as that any element is “connected”, “coupled” or “accessed” to another element, it should be understood that it is possible that still another element may “connected”, “coupled” or “accessed” between the two elements as well as that the two elements are directly “connected”, “coupled” or “accessed” to each other.

The term “on” that is used to designate that an element or layer is on another element or layer includes both a case where an element or layer is located directly on another element or layer, and a case where an element or layer is located on another element or layer via still another element layer. Like reference numerals generally denote like elements throughout the specification.

It will be understood that, although the terms “first,” “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Hereinafter, aspects of some embodiments of the present disclosure will be described in more detail with reference to the accompanying drawings.

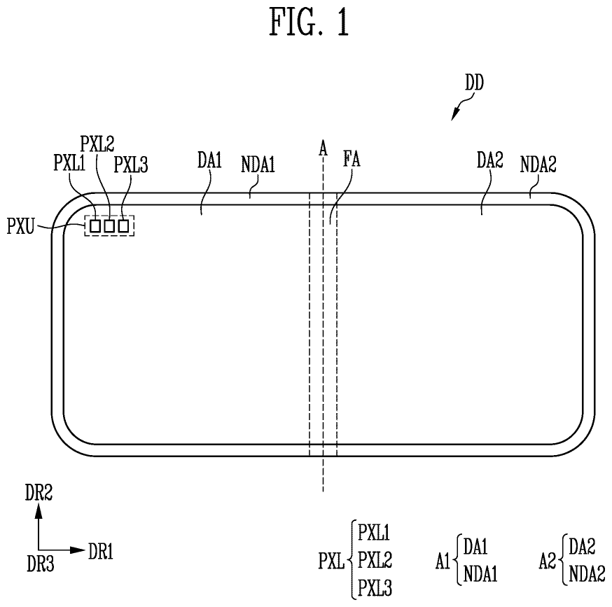

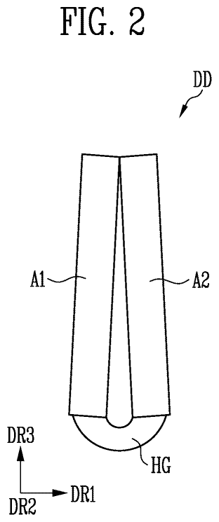

FIG. 1 is a plan view illustrating an example of an unfolded state of a display device according to some embodiments of the present disclosure. FIG. 2 is a side view illustrating an example of a folded state of the display device according to some embodiments of the present disclosure. In FIGS. 1 and 2, a foldable display device or a foldable display panel is illustrated as an example of the display device DD.

Referring to FIGS. 1 and 2, the display device DD may include a first area A1, a second area A2, and/or a folding area FA. The folding area FA may be located between the first area A1 and the second area A2. The first area A1, the folding area FA, and the second area A2 may be sequentially arranged along a first direction DR1. The folding area FA may be configured to be folded and unfolded with respect to a folding axis A (or folding line) extending in a second direction (Y-axis direction) intersecting the first direction (X-axis direction) without damaging the display device DD.

In a folded state of the display device DD, the first area A1 and the second area A2 may face each other. In an example, the first area A1 and the second area A2 may be coupled to a hinge device HG located at the folding axis A to rotate with respect to the hinge device HG. The first area A1 and the second area A2 may have shapes symmetrical to each other, but embodiments according to the present disclosure are not necessarily limited thereto.

In an unfolded state of the display device DD, the hinge device HG may be covered by the first area A1 and second area A2 not to be exposed. In the folded state of the display device DD, the hinge device HG may be at least partially exposed to the outside while the first area A1 and the second are A2 rotate.

The first area A1 may include a first display area DA1 at which images are displayed and a first non-display area NDA1 at which images are not displayed. The first non-display area NDA1 may be located at the periphery (e.g., outside a footprint) of the first display area DA1.

The second area A2 may include a second display area DA2 at which images are displayed and a second non-display area NDA2 at which images are not displayed. The second non-display area NDA2 may be located at the periphery (e.g., outside a footprint) of the second display area DA2.

The first display area DA1, the second display area DA2, and/or the folding area FA may constitute a screen at which images are displayed, and the first non-display area NDA1 and the second non-display area NDA2 may be the other area except the first display area DA1, the second display area DA2, and/or the folding area FA.

For convenience of description, in FIG. 1, a structure of the display device DD will be briefly illustrated based on the first display area DA1, the second display area DA2, and the folding area FA. However, in some embodiments, at least one driving circuit (e.g., at least one of a scan driver or a data driver), lines, and/or pads may be further located in the display device DD.

A pixel unit PXU may be located in the first display area DA1, the second display area DA2, and/or the folding area FA. The pixel unit PXU may include a first pixel PXL1, a second pixel PXL2, and/or a third pixel PXL3. Hereinafter, when at least one pixel among the first pixel PXL1, the second pixel PXL2, and the third pixel PXL3 is arbitrarily designated or when two or more kinds of pixels among the first pixel PXL1, the second pixel PXL2, and the third pixel PXL3 are inclusively designated, the corresponding pixel or the corresponding pixels will be referred to as a “pixel PXL” or “pixels PXL.”

The pixels PXL may be regularly arranged according to a stripe structure, a PENTILE™ structure, or the like. However, the arrangement structure of the pixels PXL is not limited thereto, and the pixels PXL may be arranged in the display area DA by using various structures and/or methods.

In some embodiments, two or more kinds of pixels PXL emitting lights of different colors may be located in the first display area DA1, the second display area DA2, and/or the folding area FA. In an example, first pixels PXL1 emitting light of a first color, second pixels PXL2 emitting light of a second color, and third pixels PXL3 emitting light of a third color may be arranged in the first display area DA1, the second display area DA2, and/or the folding area FA. For example, the first pixel PXL1 may be a red pixel emitting light of red, the second pixel PXL2 may be a green pixel emitting light of green, and the third pixel PXL3 may be a blue pixel emitting light of blue. However, embodiments according to the present disclosure are not limited thereto.

At least one first pixel PXL1, at least one second pixel PXL2, and at least one third pixel PXL3, which are located adjacent to each other, may constitute one pixel unit PXU capable of emitting lights of various colors. Although a case where the pixel unit PXU includes one first pixel PXL1, one second pixel PXL2, and one third pixel PXL3 is illustrated in FIG. 1, embodiments according to the present disclosure are not necessarily limited thereto, and the pixel unit PXU may include one first pixel PXL1, two second pixels PXL2, and one third pixel PXL3.

The first pixel PXL1, the second pixel PXL2, and the third pixel PXL3 may have, as light sources, a first light emitting element, a second light emitting element, and a third light emitting element, to light of the first color, light of the second color, and light of the third color, respectively. However, the color of light emitted from each pixel PXL may be variously changed.

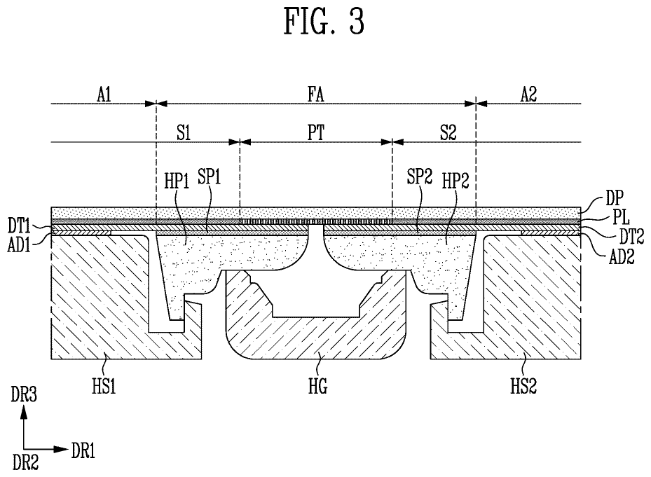

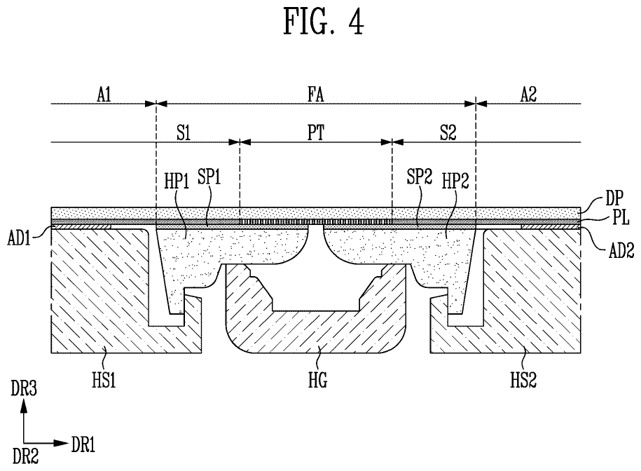

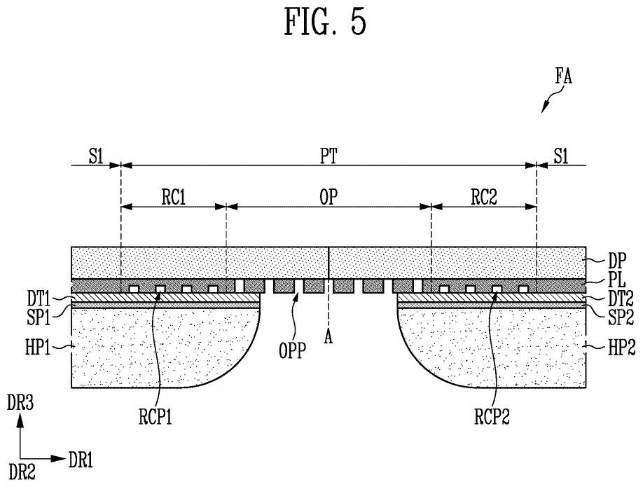

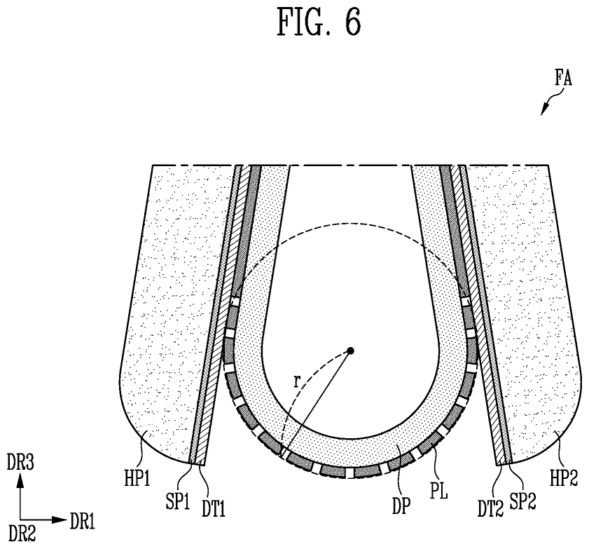

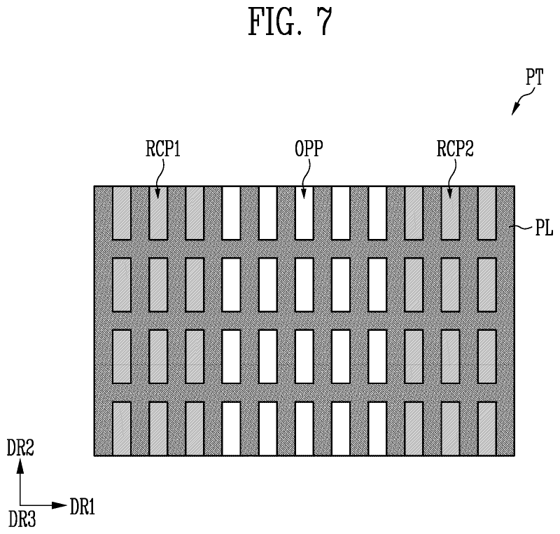

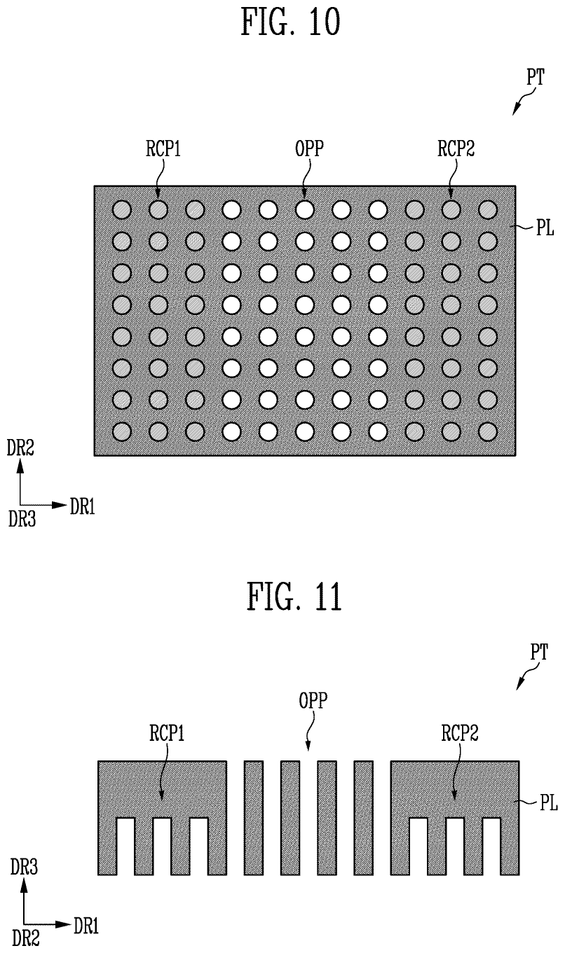

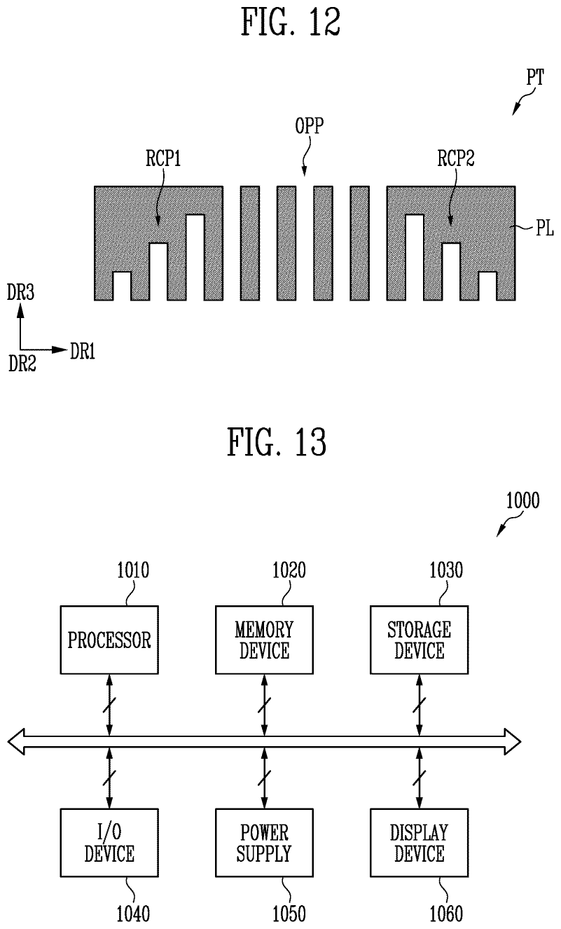

FIGS. 3 and 4 are sectional views illustrating a display device according to some embodiments of the present disclosure. FIG. 5 is a sectional view illustrating an example of an unfolded state of a folding area according to some embodiments of the present disclosure. FIG. 6 is a sectional view illustrating an example of a folded state of the folding area according to some embodiments of the present disclosure. FIGS. 7 to 10 are plan views illustrating pattern portions of a support plate according to some embodiments of the present disclosure. FIGS. 11 and 12 are sectional views illustrating pattern portions of the support plate according to some embodiments of the present disclosure.

Referring to FIGS. 3 to 6, the display device DD may include a display panel DP, a support plate PL, a hinge plate HP1 and HP2, a digitizer DT1 and DT2, a hinge device HG, and/or a housing HS1 and HS2.

The display panel DP may be accommodated in the housing HS1 and HS2. The display panel DP may be folded or unfolded with respect to a folding axis A. The display panel DP may include a first area A1 accommodated in a first housing HS1, a second area A2 accommodated in a second housing HS2, and a folding area FA folded or unfolded with respect to the folding axis A.

The support plate PL may be located on a rear surface of the display panel DP. The support plate PL may be located on the rear surface of the display panel DP to function to support the display panel DP and reinforce rigidity. The support plate PL may be formed of carbon fiber reinforced plastic, glass fiber reinforced plastic, and/or stainless steel, but embodiments according to the present disclosure are not necessarily limited thereto.

The support plate PL may include a first support portion S1, a second support portion S2, and/or a pattern portion PT. The pattern portion PT may be located between the first support portion S1 and the second portion S2. The first support portion S1, the pattern portion PT, and the second support portion S2 may be sequentially arranged along the first direction DR1.

The first support portion S1 may overlap with the first area A1 in an unfolded state of the folding area FA. The first support portion S1 may partially overlap with the folding area FA.

The second support portion S2 may overlap with the second area A2 in the unfolded state of the folding area FA. The second support portion S2 may partially overlap with the folding area FA.

The pattern portion PT may overlap with the folding area FA. The pattern portion PT may function to minimize or reduce deformation of the display panel DP in the folding area FA. Accordingly, although the display device DD is repeatedly folded or unfolded, a crease phenomenon is minimized or reduced, thereby relatively improving visibility.

The pattern portion PT may include a first recess portion RC1, a second recess portion RC2, and/or an opening portion OP. The opening portion OP may be located between the first recess portion RC1 and the second recess portion RC2. The first recess portion RC1, the opening portion OP, and the second recess portion RC2 may be sequentially arranged along the first direction DR1. That is, the first recess portion RC1 and the second recess portion RC2 may be located at an outer portion of the pattern portion PT.

According to some embodiments, a modulus of the first recess portion RC1 and/or a modulus of the second recess portion RC2 may be greater than a modulus of the opening portion OP. As such, when the outer portion (e.g., the first recess portion RC1 and the second recess portion RC2) of the pattern portion PT has a high modulus characteristic as compared with the center (e.g., the opening portion OP) of the pattern portion PT, deformation of the folding area FA can be minimized or reduced even when the display device DD is repeatedly folded or unfolded. Thus, a crease phenomenon of the folding area FA can be minimized or reduced, thereby relatively improving visibility. The modulus of the first recess portion RC1 and/or the modulus of the second recess portion RC2 may be 100 MPa or less. The modulus of the opening portion OP may be 10 MPa, but embodiments according to the present disclosure are not necessarily limited thereto.

In the unfolded state of the folding area FA, a width of the opening portion OP in the first direction DR1 may be greater than a width of the first recess portion RC1 in the first direction DR1 and/or a width of the second recess portion RC2 in the first direction DR1. The width of the first recess portion RC1 in the first direction DR1 may be equal to the width of the second recess portion RC2 in the first direction DR1.

When a radius of curvature of the folding area FA is r in a state in which the display device DD (or the display panel DP) is folded, a width of the pattern portion PT in the first direction DR1 may be (πr+2)/2 or more and πr+2 or less. A distance from the folding axis A to a first edge of the pattern portion PT (or an edge of the first recess portion RC1) in the first direction DR1 may be (πr+2)/2. A distance from the folding axis A to a second edge of the pattern portion PT (or an edge of the second recess portion RC2) in the first direction DR1 may be (πr+2)/2. In an example, the width of the pattern portion PT in the first direction DR1 may be πr+2, the width of the opening portion OP in the first direction DR1 may be (πr+2)/2, the width of the first recess portion RC1 in the first direction DR1 may be (πr+2)/4, and the width of the second recess portion RC2 in the first direction DR1 may be (πr+2)/4.

TABLE 1

| | Embodiment | Comparative Example |
|---|---|---|
| Width of pattern portion in first | 9.7 | 9.7 |
| direction (mm) | | |
| Width of opening portion in first | 4.5 | 9.7 |
| direction (mm) | | |
| Width of first recess portion in | 2.4 | 0 |
| first direction (mm) | | |
| Width of second recess portion | 2.4 | 0 |
| in first direction (mm) | | |
| Height of crease (μm) | 111 | 176 |

Referring to Table 1, it can be seen that, in the embodiments in which the first recess portion RC1 and the second recess portion RC2 are located at the outer portion of the pattern portion PT, creases are reduced by 37% as compared with the comparative example. The first recess portion RC1 may include first recess patterns RCP1. The opening portion OP may include opening patterns OPP. The second recess portion RC2 may include second recess patterns RCP2.

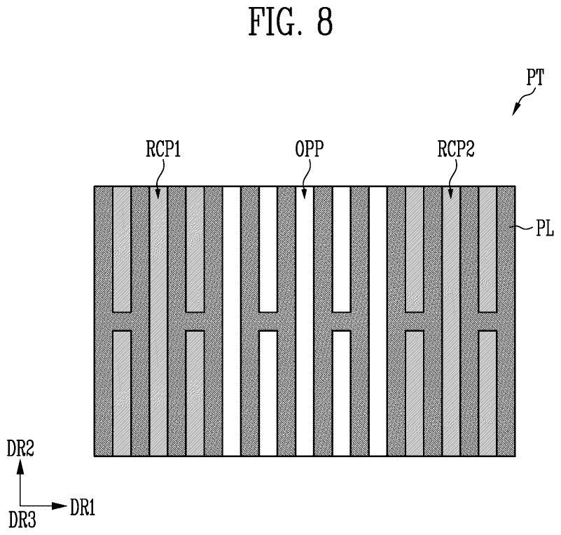

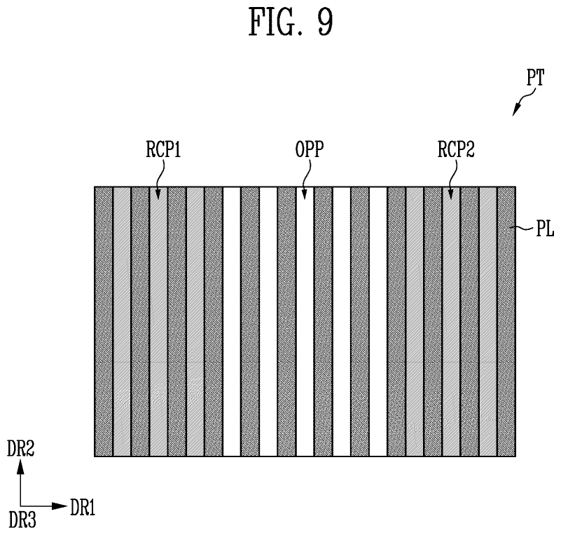

Each of the first recess patterns RCP1, the second recess patterns RCP2, and/or the opening patterns OPP may have a lattice shape on a plane as shown in FIG. 7. Alternatively, each of the first recess patterns RCP1, the second recess patterns RCP2, and/or the opening patterns OPP may have a shape in which lattices and slits are alternately arranged on a plane as shown in FIG. 8. Alternatively, each of the first recess patterns RCP1, the second recess patterns RCP2, and/or the opening patterns OPP may have a shape in which slits are successively arranged on a plane as shown in FIG. 9. However, the planar shape of the first recess patterns RCP1, the second recess patterns RCP2, and/or the opening patterns OPP is not limited to the examples shown in FIGS. 7 to 9, and may be variously changed by considering a modulus of the pattern portion PT.

Referring to FIGS. 11 and 12, the opening patterns OPP may have a penetration hole shape penetrating the support plate PL.

The first recess patterns RCP1 and/or the second recess patterns RCP2 may have a half-cut shape. The first recess patterns RCP1 and/or the second recess patterns RCP2 may have a shape recessed in a third direction DR3 from a rear surface of the support plate PL. A depth of the first recess patterns RCP1 in the third direction DR3 and/or a depth of the second recess patterns RCP2 in the third direction DR3 may be smaller than a thickness of the support plate PL in the third direction DR3. The depth of the first recess patterns RCP1 in the third direction DR3 and/or the depth of the second recess patterns RCP2 in the third direction DR3 may be smaller than a depth of the opening patterns OPP in the third direction DR3.

Referring to FIG. 11, the first recess patterns RCP1 may be formed to the same depth. The second recess patterns RCP2 may be formed to the same depth. A depth of the first recess patterns RCP1 in the third direction DR3 may be equal to a depth of the second recess patterns RCP2, but embodiments according to the present disclosure are not necessarily limited thereto.

Referring to FIG. 12, each of the first recess patterns RCP1 and/or the second recess patterns RCP2 may be formed to different depths. In an example, a depth of the first recess patterns RCP1 in the third direction DR3 and/or a depth of the second recess patterns RCP2 in the third direction DR3 may gradually become smaller as becoming more distant from the opening patterns OPP.

However, the depth of the first recess patterns RCP1 and/or the second recess patterns RCP2 in the third direction DR3 is not limited to the examples shown in FIGS. 11 and 12, and may be variously changed by considering the modulus of the pattern portion PT.

Referring back to FIGS. 3 to 6, the hinge plate HP1 and HP2 may be located on the rear surface of the support plate PL. The hinge plate HP1 and HP2 may be arranged to overlap with the folding area FA. The hinge plate HP1 and HP2 may be coupled to the hinge device HG to be folded or unfolded with respect to the folding axis A.

The hinge plate HP1 and HP2 may include a first hinge plate HP1 and/or a second hinge plate HP2. The first hinge plate HP1 and the second hinge plate HP2 may be spaced apart from each other with the folding axis A interposed therebetween.

The first hinge plate HP1 may partially overlap with the first support portion S1 in the unfolded state of the folding area FA. The first hinge plate HP1 may partially overlap with the pattern portion PT in the unfolded state of the folding area FA. The first hinge plate HP1 may overlap with the first recess portion RC1 in the unfolded state of the folding area FA. The first hinge plate HP1 may partially overlap with the opening portion OP in the unfolded state of the folding area FA.

The second hinge plate HP2 may partially overlap with the second support portion S2 in the unfolded state of the folding area FA. The second hinge plate HP2 may partially overlap with the pattern portion PT in the unfolded state of the folding area FA. The second hinge plate HP2 may overlap with the second recess portion RC2 in the unfolded state of the folding area FA. The second hinge plate HP2 may partially overlap with the opening portion OP in the unfolded state of the folding area FA.

The digitizer DT1 and DT2 may be located between the support plate PL and the hinge plate HP1 and HP2. The digitizer DT1 and DT2 may include a first digitizer DT1 and/or a second digitizer DT2. The first digitizer DT1 and the second digitizer DT2 may be spaced apart from each other with the folding axis A interposed therebetween. In some embodiments, the digitizer DT1 and DT2 may be omitted as shown in FIG. 4.

The first digitizer DT1 may overlap with the first area A1 of the display panel DP in the unfolded state of the folding area FA. The first digitizer DT1 may partially overlap with the folding area FA in the unfolded state of the folding area FA. The first digitizer DT1 may partially overlap with the first support portion S1 in the unfolded state of the folding area FA. The first digitizer DT1 may partially overlap with the pattern portion PT in the unfolded state of the folding area FA. The first digitizer DT1 may partially overlap with the first recess portion RC1 in the unfolded state of the folding area FA. The first digitizer DT1 may partially overlap with the opening portion OP in the unfolded state of the folding area FA.

The second digitizer DT2 may overlap with the second area A2 of the display panel DP in the unfolded state of the folding area FA. The second digitizer DT2 may partially overlap with the folding area FA in the unfolded state of the folding area FA. The second digitizer DT2 may partially overlap with the second support portion S2 in the unfolded state of the folding area FA. The second digitizer DT2 may partially overlap with the pattern portion PT in the unfolded state of the folding area FA. The second digitizer DT2 may partially overlap with the second recess portion RC2 in the unfolded state of the folding area FA. The second digitizer DT2 may partially overlap with the opening portion OP in the unfolded state of the folding area FA.

A spacer SP1 and SP2 may be further located between the digitizer DT1 and DT2 and the hinge plate HP1 and HP2. When the digitizer DT1 and DT2 is omitted, the spacer SP1 and SP2 may be located between the display panel DP and the hinge plate HP1 and HP2.

The spacer SP1 and SP2 may include a first spacer SP1 and/or a second spacer SP2. The first spacer SP1 and the second spacer SP2 may be spaced apart from each other with the folding axis A interposed therebetween.

The first spacer SP1 may be located between the first digitizer DT1 and the first hinge plate HP1. When the digitizer DT1 and DT2 is omitted, the first spacer SP1 may be located between the display panel DP and the first hinge plate HP1. The first spacer SP1 may partially overlap with the folding area FA in the unfolded state of the folding area FA. The first spacer SP1 may partially overlap with the pattern portion PT in the unfolded state of the folding area FA. The first spacer SP1 may partially overlap with the first recess portion RC1 in the unfolded state of the folding area FA. The first spacer SP1 may partially overlap with the opening portion OP in the unfolded state of the folding area FA.

The second spacer SP2 may be located between the second digitizer DT2 and the second hinge plate HP2. When the digitizer DT1 and DT2 is omitted, the second spacer SP2 may be located between the display panel DP and the second hinge plate HP2. The second spacer SP2 may partially overlap with the folding area FA in the unfolded state of the folding area FA. The second spacer SP2 may partially overlap with the pattern portion PT in the unfolded state of the folding area FA. The second spacer SP2 may partially overlap with the second recess portion RC2 in the unfolded state of the folding area FA. The second spacer SP2 may partially overlap with the opening portion OP in the unfolded state of the folding area FA.

The hinge device HG may be coupled to the hinge plate HP1 and HP2 to allow the display panel DP (or the display device) to be folded or unfolded with respect to the folding axis A. The hinge device HG may be configured to be rotatable with respect to the folding axis A.

The housing HS1 and HS2 may be located on the rear surface of the display panel DP. When the digitizer DT1 and DT2 is provided on the rear surface of the display panel DP, the housing HS1 and HS2 may be located on a rear surface of the digitizer DT1 and DT2. The housing HS1 and HS2 may be coupled to the hinge plate HP1 and HP2 to be folded or unfolded with respect to the folding axis A by the hinge device HG.

The housing HS1 and HS2 may include the first housing HS1 and/or the second housing HS2. The first housing HS1 and the second housing HS2 may be spaced apart from each other with the folding axis A (or folding line).

The first housing HS1 may be coupled to the first hinge plate HP1. The first housing HS1 may overlap with the first area A1 in the unfolded state of the folding area FA. The first housing HS1 may partially overlap with the folding area FA in the unfolded state of the folding area FA. The first housing HS1 may overlap with the first support portion S1 in the unfolded state of the folding area FA.

The second housing HS2 may be coupled to the second hinge plate HP2. The second housing HS2 may overlap with the second area A2 in the unfolded state of the folding area FA. The second housing HS2 may partially overlap with the folding area FA in the unfolded state of the folding area FA. The second housing HS2 may overlap with the second support portion S2 in the unfolded state of the folding area FA.

An adhesive layer AD1 and AD2 may be further located between the display panel DP and the housing HS1 and HS2. When the digitizer DT1 and DT2 is provided on the rear surface of the display panel DP, the adhesive layer AD1 and AD2 may be located between the digitizer DT1 and DT2 and the housing HS1 and HS2.

The adhesive layer AD1 and AD2 may include a first adhesive layer AD1 and/or a second adhesive layer AD2. The first adhesive layer AD1 may be located between the display panel DP and the first housing HS1. The first adhesive layer AD1 may be located between the first digitizer DT1 and the first housing HS1. The first adhesive layer AD1 may couple the display panel (or the first digitizer DT1) and the first housing HS1 to each other.

The second adhesive layer AD2 may be located between the display panel DP and the second housing HS2. The second adhesive layer AD2 may be located between the second digitizer DT2 and the second housing HS2. The second adhesive layer AD2 may couple the display panel DP (or the second digitizer DT2) and the second housing HS2 to each other.

In accordance with the above-described embodiments, the first recess portion RC1 and the second recess portion RC2, which correspond to the outer portion of the pattern portion PT of the support plate PL, have a relatively high modulus characteristic as compared with the opening portion OP which corresponds to the center of the pattern part PT. Accordingly, although the display device DD is repeatedly folded or unfolded, the deformation of the folding area FA can be minimized or reduced. Thus, the crease phenomenon of the folding area FA can be minimized or reduced, thereby relatively improving visibility.

According to some embodiments of the present disclosure, a pattern portion is formed in a support plate, so that the crease phenomenon of a folding area can be minimized or reduced, thereby relatively improving visibility of the display device.

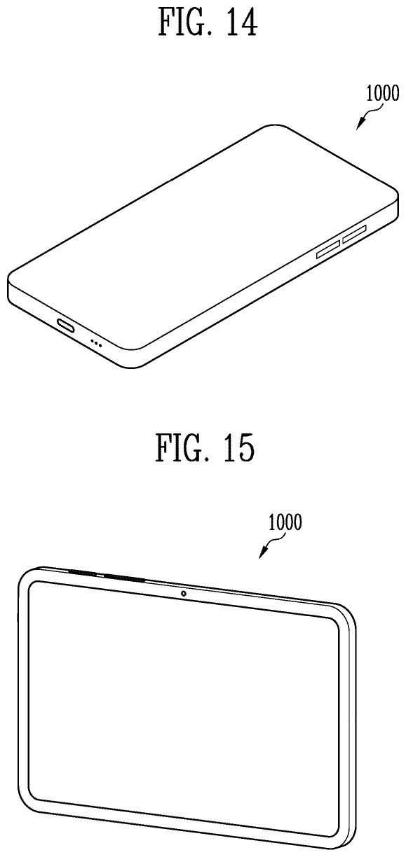

FIG. 13 is a schematic block diagram illustrating an electronic device 1000 including a display device in accordance with an embodiment. FIG. 14 is a schematic diagram illustrating an example where the electronic device 1000 of FIG. 13 is a smartphone. FIG. 15 is a schematic diagram illustrating an example where the electronic device 1000 of FIG. 13 is a tablet computer.

Referring to FIGS. 13 to 15, the electronic device 1000 may include a processor 1010, a memory device 1020, a storage device 1030, an input/output (I/O) device 1040, a power supply 1050, and a display device 1060. The display device 1060 may be the display device DD of FIG. 1. The electronic device 1000 may further include various ports for communication with a video card, a sound card, a memory card, a USB device, or other systems. In an embodiment, as illustrated in FIG. 14, the electronic device 1000 may be a smartphone. In an embodiment, as illustrated in FIG. 15, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. In an embodiment, the processor 1010 may include at least one of a central processing unit, an application processor, a graphic processing unit, a communication processor, an image signal processor, a controller, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to image data signals and/or control signals from the processor 1010. The display device 1060 may be connected to other components through the buses or other communication links.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, and their equivalents.

What is claimed is:

1. A display device comprising:
a display panel including a first area, a folding area, and a second area, which are arranged along a first direction, wherein the folding area is configured to be folded with respect to a folding axis extending along a second direction intersecting the first direction; and
a support plate on a rear surface of the display panel, the support plate including a pattern portion overlapping with the folding area,
wherein the pattern portion includes a first recess portion, a second recess portion, and an opening portion between the first recess portion and the second recess portion, and
wherein, a radius of curvature of the folding area is r in a state in which the display panel is folded, and in the state in which the display panel is folded, a width of the pattern portion in the first direction is (πr+2)/2 or more and πr+2 or less.

2. The display device of claim 1, wherein a width of the opening portion in the first direction is (πr+2)/2, and a width of the first recess portion in the first direction is (πr+2)/4.

3. The display device of claim 1, wherein a width of the first recess portion in the first direction is equal to a width of the second recess portion in the first direction.

4. The display device of claim 1, further comprising a hinge plate on a rear surface of the support plate.

5. The display device of claim 4, wherein the hinge plate includes a first hinge plate and a second hinge plate, which are spaced apart from each other.

6. The display device of claim 5, wherein the first hinge plate overlaps with the first recess portion, and the second hinge plate overlaps with the second recess portion.

7. The display device of claim 6, further comprising:
a first digitizer between the support plate and the first hinge plate; and
a second digitizer between the support plate and the second hinge plate.

8. The display device of claim 7, wherein the first digitizer and the second digitizer are spaced apart from each other.

9. The display device of claim 7, further comprising:
a first spacer between the first digitizer and the first hinge plate; and
a second spacer between the second digitizer and the second hinge plate.

10. The display device of claim 9, wherein the first spacer and the second spacer are spaced apart from each other.

11. A display device comprising:
a support plate including a first support portion, a pattern portion, and a second support portion, which are arranged along a first direction; and
a display panel on a top surface of the support plate, the display panel being configured to be folded with respect to a folding axis extending along a second direction intersecting the first direction in a folding area overlapping with the pattern portion, wherein the pattern portion includes a first recess portion, a second recess portion, and an opening portion between the first recess portion and the second recess portion,
wherein, a radius of curvature of the folding area is r in a state in which the display panel is folded, and in the state in which the display panel is folded, a width of the pattern portion in the first direction is (πr+2)/2 or more and πr+2 or less.

12. The display device of claim 11, wherein a width of the opening portion in the first direction is (πr+2)/2, and a width of the first recess portion in the first direction is (πr+2)/4.

13. The display device of claim 11, wherein a width of the first recess portion in the first direction is equal to a width of the second recess portion in the first direction.

14. The display device of claim 11, further comprising a hinge plate on a rear surface of the support plate.

15. The display device of claim 14, wherein the hinge plate includes a first hinge plate and a second hinge plate, which are spaced apart from each other.

16. The display device of claim 15, wherein the first hinge plate overlaps with the first recess portion, and the second hinge plate overlaps with the second recess portion.

17. The display device of claim 11, further comprising a digitizer on a rear surface of the support plate.

18. The display device of claim 17, wherein the digitizer includes a first digitizer and a second digitizer, which are spaced apart from each other.

19. The display device of claim 18, wherein the first digitizer overlaps with the first support portion, and the second digitizer overlaps with the second support portion.

20. The display device of claim 18, further comprising:
a first hinge plate on a rear surface of the first digitizer; and
a second hinge plate on a rear surface of the second digitizer.

21. An electronic device comprising:
a processor to provide input image data; and
a display device to display an image based on the input image data, the display device including sub-pixel areas,
wherein the display device comprises:
a display panel including a first area, a folding area, and a second area, which are arranged along a first direction, wherein the folding area is configured to be folded with respect to a folding axis extending along a second direction intersecting the first direction; and
a support plate on a rear surface of the display panel, the support plate including a pattern portion overlapping with the folding area,
wherein the pattern portion includes a first recess portion, a second recess portion, and an opening portion between the first recess portion and the second recess portion, and
wherein, a radius of curvature of the folding area is r in a state in which the display panel is folded, and in the state in which the display panel is folded, a width of the pattern portion in the first direction is (πr+2)/2 or more and πr+2 or less.
